(19) United States
(12) Patent Application Publication
(10) Pub. No.: US 2003/0182250 A1
(43) Pub. Date: Sep. 25, 2003

(54) Technique for forecasting market pricing of electricity

(76) Inventors: Mohammad Shihidehpour, Naperville, IL (US); Zuyi Li, Chicago, IL (US)

Correspondence Address: Roland W. Norris, Pauley Petersen Kinne & Erickson, Suite 365, 2800 West Higgins Road, Hoffman Estates, IL, 60195, US

(21) Appl. No.: 10/101,210

(22) Filed: Mar. 19, 2002

(51) Int. Cl. G06N 3/08; G06F 15/18; G06E 3/00; G06E 1/00; G06F 17/60; G06G 7/00

(52) U.S. Cl. 706/21; 705/10; 706/25

(57) ABSTRACT

An adaptive training application is provided to enable an entity generating or selling electricity to predict short term market prices of this non-storable commodity in a volatile market. An artificial neural network is utilized to analyze and adapt to the generating entity's unique operational situation, plant, transmission lines, geographic location, etc. and determine all factors for which data are available and which have a relevant effect upon the market price of electricity. A training stage is provided for training the artificial neural network and determining which data are relevant and the weight of the relevant data to the ultimate determination of price. An error criterion is established to test the training of the network with respect to price forecasting. Once the network is trained it is further subject to adaptive techniques to further refine the training. The trained network input matrix is utilized in a forecasting stage to predict electricity market prices. The predicted prices are further compared to actual prices and the neural network is further adapted as necessary.

### BACKGROUND OF THE INVENTION

The present invention presents a system for forecasting market price of electricity through the use of an artificial neural network, often simply referred to as a neural network, which is trained on data beyond that of the historical time and load data for the transmission network to achieve a more accurate forecasting.

In the past, the market for electrical power was often a regulated monopoly. With the deregulation and restructuring of the electrical power industry, electricity price forecasting is becoming essential to operating a power market. Electricity is a unique commodity in that it is a non-storable commodity and its supply and demand must be matched at all times. If supply and demand are not carefully matched, maintaining the 60 hertz frequency would become a serious problem. Further the economics of electricity generation involve supply and demand dynamics which interact constantly. Therefore, the price for electricity is often determined for short-time periods.

Electricity prices are strongly related to physical characteristics of a power system such as loads, hydrological conditions, fuel prices, generating unit operating characteristics, emission allowances, and transmission capability. Electricity cannot be stored economically and transmission congestion may prevent free exchange of electricity among control areas. Thus, electricity price will show greater volatility than most other commodities, and if available algorithms used for forecasting prices of other commodities are utilized for electricity price forecasting, fairly low forecasting accuracy might be achieved.

The demand for electricity varies significantly according to the time of day. Electricity demand is higher during day-time hours, known as the peak period, and lower during night-time hours, known as the off-peak period. Without the possibility of storage, which is an essential feature in other commodity markets, it is impossible to smooth out electricity prices between peak and off-peak periods. Regionally, electricity demand will also vary seasonally, with some areas experiencing their peak demand during the summer while others would peak in the winter. The demand for electricity can be very uncertain, as it is largely weather related.

Because of the limited available information, the accuracy of price forecasting for an electricity generating entity may not be high. However, an accurate estimation of price could help a generating entity determine its bidding strategy or set up bilateral contracts more precisely and in general be more economically viable.

Because the deregulation and restructuring of electricity markets is a new phenomenon, there are few existing methods for the forecasting of the price of electricity. Further, there is lack of reliable data on the myriad factors which may effect the price at which the electrical generating entity can sell their commodity. While price forecasting has been utilized in other commodity markets, the electricity market poses a unique challenge because electricity is non-storable, and data are limited. Past study has focused largely on the time versus price data and time versus demand, or load, data rather than supply side factors affecting the generation and transmission of electricity. Further complicating the price forecasting is the fact that electricity is subject to severe price volatility due to factors within the electrical distribution network, or grid, such as flow congestion within the grid and lack of production resources for the generating entity, such as fossil fuel or hydropower shortages which may occur seasonally. Generating plant outages, and geographical and demand diversities within the network may further contribute to price volatility. Beyond these common problems, it will be appreciated that each generating plant is unique due to location, generating type, cost overhead, etc.

Further, owing to the fact that plants are expensive to build and operate, and that electricity must be generated in bulk, it will be appreciated that the supply and quality of electrical power must depend upon the ability of the generating entities to adequately predict, or forecast, the sale price of their electricity in order to stay in business in a deregulated market.

While no such method known to the Applicants exists in the art, it would be helpful for a generating entity to have a method to forecast one or more types of electricity market price. Within an electricity market there may be a marginal clearing price (MCP), locational marginal price (LMP) and zonal marginal clearing price (ZMCP), for the entire system, for a specific bus and for a specific zone, respectively. Within the electricity market, when there is no transmission congestion, MCP is the only price for the entire system. When there is congestion, ZMCP or LMP will be employed.

For calculation of MCP, the auctioneer, e.g., an Independent System Operator (ISO) or Power Exchange (PX), receives supply bids and demand bids. The auctioneer then aggregates the supply bids into a supply curve (S) and aggregates the demand bids into a demand curve (D). The intersection of (S) and (D) is the MCP, as is illustrated in FIG. 1.

After the auction, the Power Exchange requires market participants to convert energy schedules in their portfolios into Initial Preferred Schedules (IPSs) and also submit optional Schedule Adjustment Bids (SABs). Then Initial Preferred Schedules as well as Schedule Adjustment Bids are submitted to the Independent System Operator. For every period, the Independent System Operator studies the proposed schedules for potential transmission congestion. If no congestion is detected, the Independent System Operator will accept the Initial Preferred Schedules without any adjustments as final schedule, and the Power Exchange uses the MCP as the energy price. If in any periods, the Independent System Operator detects congestion across transmission paths, it will adjust zonal schedules at the two ends of each path to relieve the congestion. The Independent System Operator relies on the Schedule Adjustment Bids to determine which schedules to adjust, and by how much, in order to relieve congestion at the lowest possible cost. The congestion charge for each congested transmission path is calculated based on Schedule Adjustment Bids across that path. The Power Exchange receives the final energy schedules and congestion charges from the Independent System Operator, and recalculates a set of ZMCPs to reflect the Independent System Operator's transmission congestion charges that are potentially different from one zone to the next.

For a generating entity, price forecasting means predicting MCP, ZMCP, or LMP before submitting bids. A generating entity will likely know very little about other generating entities and will only have access to the publicly available information, including forecasted load and data such as loads, MCPs, etc.

In known systems, because of limited available information, the accuracy of price forecasting for a generating entity may not be high. However, an accurate forecast, i.e., an estimation of the sale price, would help a generating entity determine its bidding strategy or set up bilateral contracts more precisely. A bid closer to the market price would result in a higher income for a generating entity. Also, a generating entity may more accurately control its operations if it can predict the market price more accurately, because a bidder who has a generating unit with marginal cost close to the expected MCP could benefit from withholding that generating capacity.

Known attempts at aiding the electricity producers in the prediction of price for their commodity include U.S. Pat. No. 5,974,403, which presents a system to simulate the spot prices of electricity by solving an Optimal Power Flow problem by considering the probability distribution of generation and load. A simple neural network system for electricity price prediction is disclosed in, A. Wang, B. Ramsay, “Prediction of System Marginal Price in the UK Power Pool Using Neural Networks,” 0-7803-4122-8/97, 1997, IEEE. In Wang, a simple data structure of time and demand, i.e. load, is used to forecast the system-wide price for one particular price-fixing time. While basic applications may provide suitable results when grid conditions are static and operating at historic norms, changing conditions may radically alter the price structure of the electrical market. Also, there is a vast body of knowledge connected to the operation of neural networks. For example, U.S. Pat. Nos. 5,809,488; 5,563,983; and 5,444,819 discuss the application of neural networks to various problem solving. However, to Applicant's knowledge, no use of neural networks has been employed to solve the elaborate problem of allowing an individual electricity generating plant to adequately forecast the sale price of electricity based on the myriad market and operational factors necessary to achieve a sale price forecast sufficient to allow consistently viable operation in a deregulated electricity market.

### SUMMARY OF THE INVENTION

A solution to the above problems in set forth by the present invention, which in certain aspects call for the application of a technique whereby a neural network is trained to define a wide range of the transmission congestion, generating reserve, and market power or bidding factors impacting on the price of electricity for a particular generating plant. Such variables may include transmission line limits, line outages, transmission line maintenance schedules, transmission network congestion statistics, load patterns, bidding patterns, types of generators within the grid, generator outages within the grid, generator capacity within the grid, maintenance schedule of generators within the grid, market power of bidders, time (hour, day, month), and line load and flow statistics, where available.

These variables will be used as inputs into the training stage of the neural network in order to determine the relevance and weight of the factors to the ultimate price forecasting. Because the neural network of the present invention is adaptive, the factors will be constantly evaluated and reassessed for training of the neural network. Newly gathered data may further be input to the training stage as it becomes reliably available. Training of the neural network may utilize the oversight of a human expert in price forecasting as well as techniques including the preprocessing of data to eliminate resultant abnormalities and the selection of an adequate formula for determining forecasting error, such as a modified, or nontraditional, Mean Absolute Percentage Error (MAPE) to judge the relevance/error of the forecasting results. Preprocessing of data, such as to eliminate extreme volatility of price spikes, may be utilized in the training of the network. A proper training period can be determined based on the factors necessary to achieve an acceptable forecasting error while maintaining efficiency of the training. Presently, generally acceptable training and testing periods for the neural network have been found to be four weeks and one week, respectively, as further discussed below. Testing of neural networks for the present invention has indicated that a supervised, feedforward neural network of one input layer, one hidden layer, and one output layer may be utilized with the present invention. In one embodiment, the present invention may have a neural network comprises an input layer of 73 neurons, a hidden layer of 100 neurons, and an output layer of 24 neurons. Once the trained network is utilized to forecast electricity prices, the neural network forecasting is further monitored against actual pricing in order to further adapt the forecasting.

The training stage of the neural network application will determine which variables are relevant, and what degree or weight, each variable, neuron, or individual input to be parallel processed, is to be accorded. Initially, each variable will be entered into a commercial algorithm development tool such as MATLAB® from The Mathworks Inc. of Natick, Mass., or other commercial algorithm for the solving of transfer functions. The character and amount of data can be examined to determine whether sigmoid, linear, hyperbolic tangent, or other known transfer functions are best utilized by the present invention for efficient training of the neural network. Each variable will be iteratively evaluated against actual data for efficiency and accuracy of the training so that the network is not over-trained to a point of wasteful or inaccurate complexity and the proper forecast accuracy is obtained. As the training stage is adapted to the proper inputs and weights of neurons, the input matrix of the forecasting stage can then be determined to develop the actual forecasting stage. The forecasting stage will also be adaptively maintained by checking the forecast prices against actual data and adapting the forecasting stage of the neural network if the forecast prices are not matching expected accuracy to the actual market prices.

Thus, according to one aspect of the present invention, an adaptive method for forecasting the market price of the nonstorable electricity commodity by using an neural network may comprise the gathering of accurate data for a plurality of factors including transmission congestion, generating reserve, bidding patterns, and the like which may effect bid price of electricity, feeding the factors into a training stage for the neural network, establishing a criteria for forecast accuracy for the trained network, determining the type and amount of factors relevant to an efficient forecasting algorithm for the sale price of electricity in the generating entity's market, using those factors to develop actual predictions of bid price of electricity, comparing the forecast price of electricity to the actual market actual price of electricity, and adapting the factors if the accuracy criteria is exceeded. The method of the present invention may be used to forecast short term or long term pricing in the market.

### BRIEF DESCRIPTION OF THE DRAWINGS

FIG. 1 shows a graph of a supply curve and a demand curve to illustrate calculation of the marginal clearing price (MCP).

FIG. 2 shows a schematic overview of the adaptive forecasting system for electricity pricing according to one embodiment of the present invention.

FIG. 3 shows a schematic neural network model for considering various physical factors of an electrical system.

FIG. 4 shows a graph of a congestion index function based on line limit and line flow physical factors of an electrical system.

FIG. 5 shows a schematic neural network model for considering congestion index as a physical factor of an electrical system.

FIG. 6 shows a graph of the impact of the amount of training time on the neural network.

FIG. 7 shows a graph of the impact of the amount of physical factors on the training of the neural network for predicting marginal clearing price (MCP).

FIG. 8 shows a graph of the impact of the amount of physical factors on the training of the neural network for predicting zonal marginal clearing price (ZMCP).

### DETAILED DESCRIPTION

According to the present invention described herein, a new technique is disclosed for price forecasting in restructured electricity markets. The application of this process allows electric power generators and distributors to maximize revenue by increasing their knowledge of short-term supply and demand changes. The exemplary embodiment focuses on short-term price forecasting although the person having ordinary skill in the art will appreciate that the methods described herein will be readily adapted to a more long-range forecasting.

One embodiment of the present invention generally comprises two stages: the training stage and the forecasting stage. Each stage is an adaptive process in the sense that it includes a feed back process which allows a neural network to learn from its mistakes and correct its output by adjusting its neurons.

The present invention shows that line flow limits, line outages, load patterns, bidding patterns and generator outages significantly impact electricity market price. The present invention shows that good data pre-processing is helpful in that using too many training inputs or considering too many factors are not good for price forecasting. The present invention also shows that adaptive forecasting improves forecasting accuracy. A more reasonable definition of forecasting error presented herein further avoids the limitations of traditional methods for evaluating the performance of electricity price forecasting. Therefore, the neural network method, with appropriate training strategies including data pre-processing, a feedforward, supervised, neural network model of 73 input neurons, 100 hidden neurons and 24 output neurons, the appropriate amount of data training (e.g. 4 weeks), and the adaptive forecasting strategy, is a good tool for price forecasting compared to other simple methods in terms of accuracy as well as convenience.

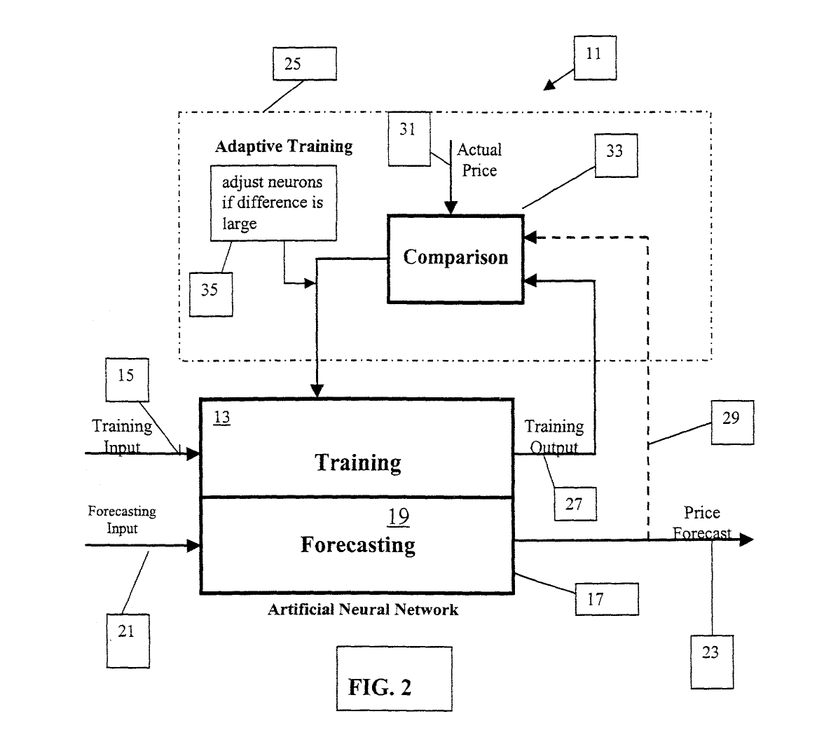

FIG. 2 generally depicts the forecasting process 11. At the training stage 13, the proper training matrix of data inputs 15 to the neural network 17 is identified, the proper structure for the neural network 17 is further identified, and the neural network is developed for price forecasting. The sophistication of the training stage will depend in some instances on the type of application that is proposed for the forecasting application (marketing, generation, etc).

The training stage may be cumbersome and inaccurate if not maximized for efficiency. For instance, the over-training of neurons can seriously deteriorate the forecasting results. Furthermore, training the neural networks based on a training matrix that is very different from the input matrix can also damage the forecasting results and the performance of forecasting. At the forecasting stage 19, the proper input matrix 21 is applied to the trained network 19 to obtain the price forecast 23.

One aspect of the present invention includes adaptive training 25 of neural networks 17. Each of the training stage 13 and the forecasting stage 19 will have its forecast output 27, 29, respectively, compared against the actual market price of electricity 31 and subjected to a criterion such as a nontraditional MAPE, as at block 33, to determine an acceptable error level, as further discussed below. Adjustment of the neurons of the neural network may take place, as at box 35, where the error criterion is exceeded. Essentially, the forecasting technique of the present invention is adaptively trained for each individual potential application, i.e. generating entity. The training may depend on the available data to establish the level of sophistication of the training matrix, the physical behavior of the power systems and the proposed use (i.e., marketing, power production, regulatory issues) of the forecasted price. In each application, the neural network will capture the previous experience of individual users in price forecasting, and apply that experience in training the forecasting application. The adaptive training process will enhance the performance of the forecasting application as additional training data becomes available.

The content of the training matrix that will be used for training the neural networks may also depend on the intended type of forecasting application. Several physical factors can be considered in the training matrix such as: transmission line flow limits, line outages, transmission line maintenance schedule, transmission network congestion statistics, load patterns, types of generators, generator outages, generator capacity, maintenance schedule of generators, etc. Pricing data such as bidding patterns, market power of bidding participants, and indications of unfair competition may further be considered as inputs. Market power is the power of a market participant to be able to manipulate the market and is modeled similar to congestion. Thus, there may be an indicator representing the market power of certain participants who can increase the MCP artificially. In order to determine the impact of physical factors on price forecasting, the training stage may calculate the sensitivity of electricity price to these factors and apply those results in arriving at the input matrix for the ultimate forecasting application The content of the input matrix that will be used for calculating the actual price forecast will depend very much on the physical factors that are going to be used as input to the neural networks. The input matrix can be tested by applying a set of practical input data representing the state of the power system for which forecasting is being performed to the trained neural network and comparing the proposed price forecasting results with actual pricing data.

There are many physical factors that could impact electricity market price. In practice, it is impossible to include all factors in price forecasting, whether because the factors are unknown or the related data are unavailable. A sensitivity analysis which shows the impact of individual input variables on the price forecast can be used to select the prominent factors used for inputs for training the neural network of the present invention. Given a factor, if the price is insensitive to this factor, it is assumed that the factor is not currently impacting the price and may be ignored with minute error in price forecasting.

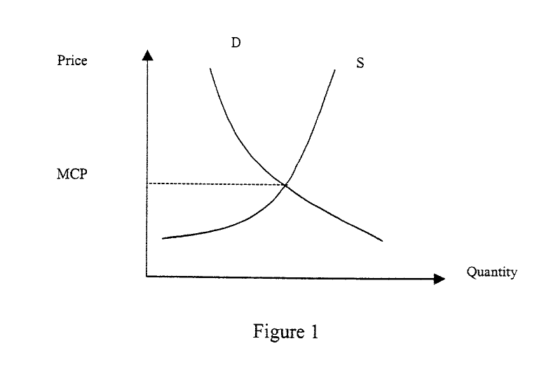

An analysis of MCP price variations and some physical examples therewith presents a conceptual understanding of how factors might affect the electricity price. The following 8 analyses are based on the graph of FIG. 1.

(1) Fuel prices increase. Generating Entities therefore increase their price. The S curve is shifted upward; the MCP increases and the quantity of electricity decreases.

(2) Fuel prices decrease. Generating Entities therefore decrease their price. The S curve is shifted downward; the MCP decreases and the quantity of electricity increases.

(3) Demand for electricity increases. The D curve is shifted upward; the MCP increases and the quantity increases.

(4) Demand for electricity decreases. The D curve is shifted downward; the MCP decreases and the quantity decreases.

(5) A generator outage occurs (or a bid is withdrawn). The S curve is shifted to the left; the MCP increases and the quantity decreases.

(6) A new supplier enters the market or a generator is restored. The S curve is shifted to the right; the MCP decreases and the quantity increases.

(7) Demand for electricity decreases. The D curve is shifted to left; the MCP decreases and the quantity decreases.

(8) A new demand enters the market. The D curve is shifted to right; the MCP increases and the quantity increases.

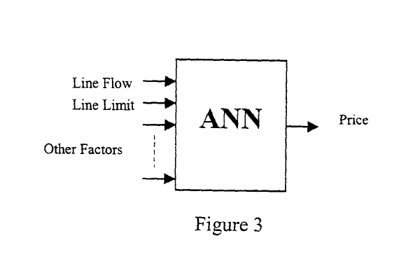

Beyond consideration of apparent factors for which data exists such as time and temperature, transmission congestion is an additional factor which could cause differences in price among buses (areas or zones of the grid). Therefore, predicting the severity of congestion may be an important factor in price forecasting. Transmission congestion occurs when a transmission line flow would exceed its limit. So, line flow and line limit information together could reveal line flow congestion and its severity. Thus, to find the relationship between congestion and price, the present invention may calculate the relationship between line flow, line limit, and price. There are two ways for determining this relationship using neural networks. First, the training may take line limits and line flows as direct inputs to neural networks, as shown in FIG. 3.

The problem of adequately modeling the congestion on transmission lines may escalate if there are many transmission lines to consider, hence, the training may opt to consider major (e.g., inter-zonal) lines only. Another input option would be to define a congestion index which includes line flow and line limit information and is able to convey a physical meaning for the impact of line flows and limits on system behavior. A congestion index can be defined as follows:

$$CongestionIndex = {\sum }_{i} f ( {Linelimit}_{i} - {Lineflow}_{i} ) \qquad ( Eq . 1 )$$

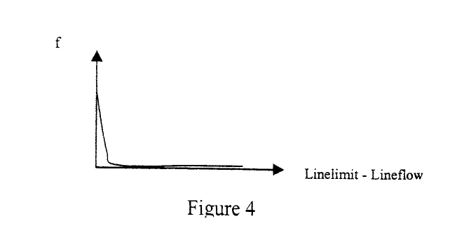

The f function is illustrated in FIG. 4.

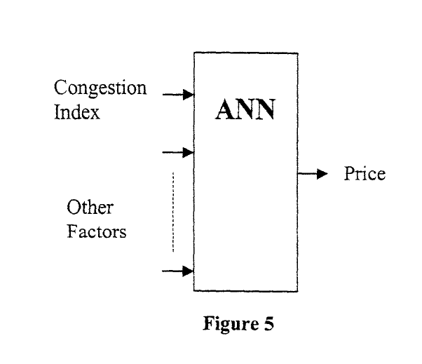

FIG. 4 shows that when a line flow is close to its limit, the possibility of congestion is high; when the line flow is much less than its limit, the congestion possibility would be smaller. This index value may be used as an input to neural networks as depicted in FIG. 5. The difference between the two options is that the latter would only have one input with respect to congestion.

Other factors considered in electricity price forecasting could be: time, including: hour of the day, day of the week, month, year, and special days; load, including: historical and forecasted load; reserve capacity, including: historical and forecasted reserve; and historical price of electricity, e.g., including the actual price of electricity for the last two days.

Additional factors may include fuel price where data exist to approximate the impact of fuel price on MCP, for example, a “10 percent increase in the generating entity's gas price could cause about 5 percent increase in MCP.” However short term or recent data may indicate the fuel prices are nearly invariant in a training period.

Other factors may include the impact of load variations on price and price variations on load values. Thus, load forecasting and price forecasting might be combined into a single forecasting model. However, because of significant price volatility, it may be difficult to make an accurate price forecast based on this relationship. Up to now, the least reported error for price forecasting is about 10% as compared to 3% error for load forecasting. However, the accuracy for price forecasting is not as stringent as that of load forecasting.

Considering neural network training techniques for the present invention it was realized that the criterion for analyzing forecasting error should not be based upon traditional mean average percent error, or MAPE, and therefore the criterion must be modified such as by using a Modified MAPE for the establishment of meaningful forecasting error. Traditionally mean average percent error, or MAPE, is widely used to evaluate the performance of electricity load forecasting. However in price forecasting, MAPE is not a reasonable criterion as it may lead to inaccurate representation.

For example, let Vₐ be the actual value and V_{f} the forecast value. Then, Percentage Error (PE) is defined as

PE=(V_{f}−Vₐ)/Vₐ*100% (Eq. 2)

and the Absolute Percentage Error (APE) is

APE=|PE| (Eq. 3)

then, the Mean Absolute Percentage Error (MAPE) is given as

$$MAPE = \frac{1}{N} {\sum }_{i = 1}^{N} {APE}_{i} \qquad ( Eq . 4 )$$

A problem thus arises with the use of traditional MAPE to determine price forecasting error. If the actual value is large and the forecasted value is small, then APE (or MAPE) will be close to 100%. In addition, if the actual value is small, APE could be very large if the difference between actual and forecasted values is small. For instance, when the actual value is zero, APE could reach infinity if the forecast is not zero. So, there is a problem with using APE for price forecasting training. This problem also arises in load forecasting, since actual values are rather large, while price could be very small, or even zero.

Therefore, one technique of the present invention determines forecasting error using an alternative MAPE, with one example as follows:

First we define the average value for a variable V:

$$\overline{V} = \frac{1}{N} {\sum }_{i = 1}^{N} {V}_{a} \qquad ( Eq . 5 )$$

Then, we redefine PE, APE and MAPE as follows:

Percentage Error (PE):

PE=(V_{f}−Vₐ)/\overline{V}*10% (Eq. 6)

Absolute Percentage Error (APE):

APE=|PE| (Eq. 7)

Mean Absolute Percentage Error (MAPE):

$$MAPE = \frac{1}{N} {\sum }_{i = 1}^{N} {APE}_{i} \qquad ( Eq . 8 )$$

Essentially, the average value is used to avoid the problem caused by very small or zero prices when utilizing a traditional MAPE.

The present invention further reveals that data preprocessing is a valuable technique for the training and forecasting stages of the neural network. A four week training period and a one week testing period were conducted for an embodiment of the present invention. Two data pre-processing methods for eliminating price spikes were considered: limiting price spikes and excluding price spikes. Preprocessing of this data by limiting price spikes (for example, if the price is larger than 50 $/MWh, set it to 50 $/MWh), improved both the training performance and testing performance, with the training MAPE at 7.66% and the testing MAPE at 13.82%. By excluding the days with price spikes, the training performance and testing performance both improved more significantly, with a training MAPE of 5.35% and a testing MAPE of 11.43%. Consequently, without the interference of price spikes, network training can find a more general input-output mapping. Thus, testing MAPE is also improved. However, since price spikes are indicative of abnormalities in the system, it is not recommended to delete them totally from the training process.

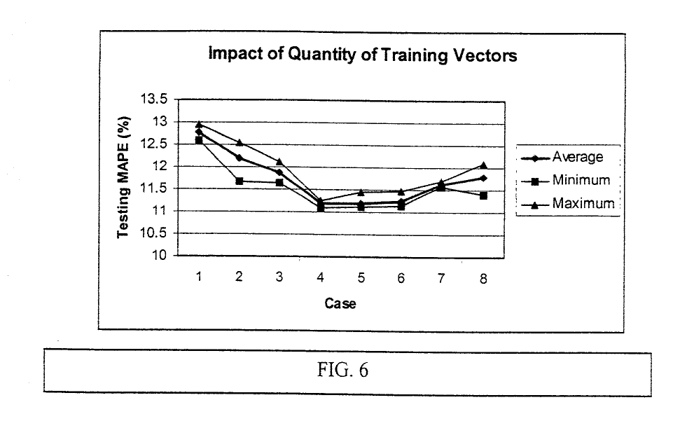

The amount of training, and particularly the amount of training time, is also a valuable consideration in construction of neural networks according to the present invention. Referencing FIG. 6, the impact of the quantity of training vectors on forecasting performance is shown. The testing period for the neural network, as performed for a specific generating entity, is fixed at a particular one week period. The training period is varied from 1 week to 8 weeks, i.e., 1-8 vectors, and the Case No. corresponds to the number of weeks in training. Since the weights of neural network are initialized randomly, every time the neural network is trained and tested, a somewhat different result is obtained. To decrease the effect of random error, the training and testing procedure is repeated five times for each case with the results shown in FIG. 6. As shown, the testing MAPE first decreases with the increase in the quantity of training vectors from Case 1 to Case 4, then remains substantially flat from Case 4 to Case 6, and finally increases from Case 6 to Case 8. Initially, by introducing more training vectors, a more diverse set of training samples results in a more general input-output mapping. Thus, the forecasting performance, measured by the testing MAPE, improves. However, as the number of training vectors is increased, the diversity of training samples no longer increases and the additional training does not improve the forecasting results. Thus, the forecasting performance remains substantially flat from Case 4 to Case 6. By further increasing the number of training vectors, in Cases 6 through 8, the neural network may be over-trained. In other words, the neural network has to adjust its weights to accommodate the input-output mapping of a large number of training vectors that may not be similar to the testing data. Thus, the forecasting performance can get worse with a farther increase of training vectors.

From the above analysis, the training quality could depend on both the diversity and the similarity of training vectors at certain points in time. Thus, a midrange of vectors, e.g. Cases 4 through 6, represent a reasonable compromise between diversity and similarity. Considering further, Case 4, i.e. 4 vectors or weeks of training, requires a smaller training time than Cases 5 and 6. So Case 4 may be preferable since it can get a good forecast with a smaller testing MAPE in less training time. For other generating entities, or markets, it may be preferable to first perform similar testing and determine the best vector choice accordingly. In general, the forecasting results are improved not by considering the most number of factors per se, but rather by considering the most number of the factors that impact the forecasting results.

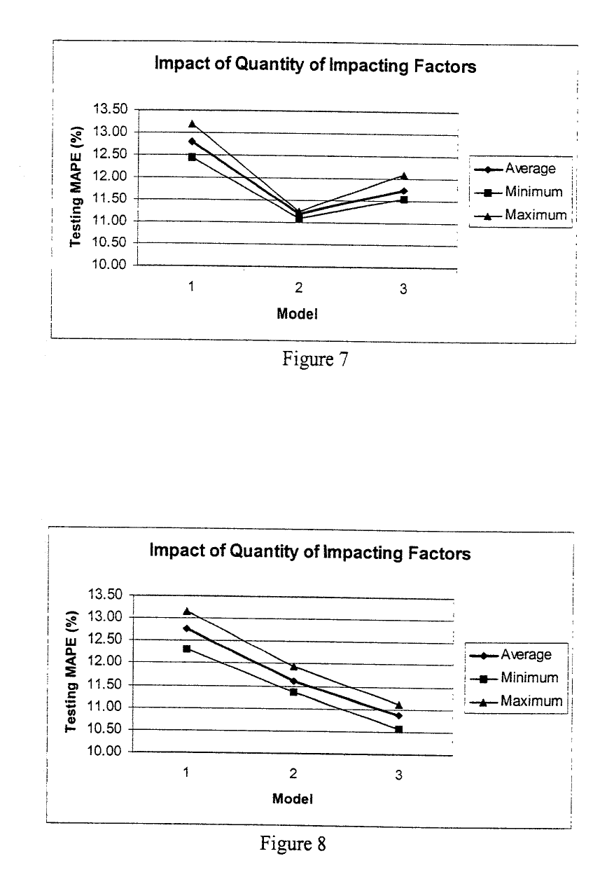

Referencing FIGS. 7 and 8, both MCP and ZMCP, respectively, were studied in relation to the number of factors on forecasting training. The evaluation of factors on ZMCP is more complicated than MCP since ZMCP is related to system congestion. It is not easy to consider the impact of congestion because very little public information on congestion is available. However, other factors such as system reserve may indirectly provide the congestion information. So, by considering the reserve information, improvement of the forecasting accuracy of ZMCP is anticipated. The ZMCP studied is that of Zone “NP15”, one of the 24 zones of the California market in 1999.

Three types of neural network models are shown in Table 1 according to the factors considered therein. Type 1 Model (T1M) is a, 1 input layer 1 hidden layer and 1 output layer, feedforward neural network, with 25 input neurons, 40 hidden neurons, and 24 output neurons. Type 2 Model (T2M) is a 1 input layer 1 hidden layer and 1 output layer, supervised, feedforward neural network, with 73 input neurons, 100 hidden neurons, and 24 output neurons, typically using a sigmoid transfer function. Type 3 Model (T3M) a is 1 input layer 1 hidden layer and 1 output layer, feedforward neural network, with 121 input neurons, 150 hidden neurons, and 24 output neurons.

TABLE 1
Factors Considered in Different Types of Model

| Factors | Type 1 (T1M) | Type 2 (T2M) | Type 3 (T3M) |
|---|---|---|---|
| Time | ✓ | ✓ | ✓ |
| Historical MCP | ✓ | ✓ | ✓ |
| Historical Load | | ✓ | ✓ |
| Forecasted Load | | ✓ | ✓ |
| Historical Reserve | | | ✓ |
| Forecasted Reserve | | | ✓ |

Note: “historical” information refers to the “previous day” information in this table.

A five week study period was conducted with a training period of four weeks and a testing period of one week. The training and testing procedures are repeated five times for each type of model and the average MAPE results are presented. The MCP results are shown in Table 2, and the ZMCP results are shown in Table 3.

TABLE 2
Forecasting Performance of Different Models - MCP Case

| | |
|---|---|
| Network | Testing MAPE (%) |

| | | | | |
|---|---|---|---|---|
| Type | Structure | Average | Minimum | Maximum |

| | | | | |
|---|---|---|---|---|
| TM1 | 25-40-24 | 12.81 | 12.44 | 13.20 |
| TM2 | 73-100-24 | 11.19 | 11.11 | 11.25 |
| TM3 | 121-150-24 | 11.75 | 11.56 | 12.11 |

(Note: in the “Network Structure” column, “25-40-24” means “25 input neurons, 40 hidden neurons and 24 output neurons”)

TABLE 3
Forecasting Performance of Different Models - ZMCP Case

| | Network | Testing MAPE (%) | | |
|---|---|---|---|---|
| Type | Structure | Average | Minimum | Maximum |
| TM1 | 25-40-24 | 12.75 | 12.31 | 13.16 |
| TM2 | 73-100-24 | 11.61 | 11.37 | 11.94 |
| TM3 | 121-150-24 | 10.88 | 10.56 | 11.12 |

(Note: in the “Network Structure” column, “25-40-24” means “25 input neurons, 40 hidden neurons and 24 output neurons”)

Referencing FIG. 7, for MCP, if only price is considered as input to the neural network (i.e., T1M), the worst forecasting performance is obtained. By considering the additional load information (historical and forecast load) as input to the neural network (i.e., T2M), a better forecasting performance than that of T1M is obtained. However, if further reserve information (historical and forecast reserve) is considered as input (i.e., T3M), the forecasting performance does not improve and even gets worse as compared with that of T2M.

Referencing FIG. 7, the MCP case, price forecasting is closely related to historical information on prices and loads, and the reserve information does not impact MCP significantly. This is expected since MCP is merely determined by matching supply and demand bids without considering power system structure and operating constraints.

Referencing FIG. 8, the ZMCP case, price forecasting is impacted by historical price, load, and reserve information. Here, the reserve information may act as an indicator of the system congestion by impacting the zonal price. For the ZMCP case, the more factors considered, the better forecasting quality is obtained. T3M considers the most factors and shows the best forecasting performance.

If a factor does not impact price forecasting, e.g., the reserve information in T3M for the MCP case, it may worsen the forecasting results if considered. The reason is that such a non-impacting factor could interfere with the training of the neural network and make it more difficult to find the mapping between the price and the impacting factors. Failure to consider a factor that does impact price forecasting, e.g. reserve information in T2M for the ZMCP case, may affect the forecasting performance adversely.

Testing of the present invention has revealed that adaptive forecasting methods, wherein the training weights are updated frequently according to the testing and forecasting results, is preferable to assigning static weights to the data.

By studying the profile of price curves, one would expect that the adaptive modification of network weights would provide a better forecast. In Table 4, a Type 2 model (T2M) is employed and results are shown for comparing non-adaptive and adaptive methods.

TABLE 4
Comparison of Non-adaptive and Adaptive Forecasting

| | | | |
|---|---|---|---|
| Case | Training | Testing | Testing MAPE (%) |

| No. | Vectors | Vectors | Non-adaptive | adaptive |
|---|---|---|---|---|
| 1 | 2/1 thru 2/28 (28) | 3/1 thru 3/7 (7) | 14.04 | 8.71 |
| 2 | 5/1 thru 5/28 (28) | 5/29 thru 6/4 (7) | 52.94 | 25.81 |
| 3 | 7/1 thru 7/28 (28) | 7/29 thru 8/4 (7) | 12.53 | 12.59 |
| 4 | 8/1 thru 8/28 (28) | 8/29 thru 9/4 (7) | 11.59 | 10.23 |

Note: in “training vectors” and “testing vectors” (28) means “28 vectors”

From Table 4 it is seen that in most cases adaptive forecasting gives better accuracy. The reason is that adaptive forecasting takes the newest information into consideration. In Table 4, Case No. 2 deserves more attention where zero prices occur in 5/29, 5/30 and 5/31 and non-adaptive forecasting would not identify this information. In comparison, adaptive forecasting can identify this information and modify network weights accordingly. Adaptive modification of neural network weights is thus essential for maintaining good forecasting. Referencing Table 5, the modified, or redefined, MAPE definition is used to compare forecast quality of the neural network method with alternative methods. The present invention, i.e., a neural network of the Type 2 Model, i.e., inputs are time, previous day MCP, previous day load and forecast load to forecast MCP, with a 73 input neurons—100 hidden neurons—24 output neurons structure, using four weeks' history data for training and the data pre-processing technique, is presented.

In alternative method 1 (AM1), “using current day data” means using the data of “day i” to forecast the price of “day i+1”, while “using previous day data” means using the data of “day i−1” to forecast the price of “day i+1”. The former is an ideal situation since in practice it is impossible to get current day data when forecasting the next day price. However, the latter is the normal situation in practice.

In alternative method 2 (AM2), the following strategy is employed to determine the so-called “similar error”. Suppose only load information is considered to forecast price (the idea can be easily extended to consider more information). L is the forecasted load. HL is the historical load. Suppose the relationship between L and HL can be found as HL=k*L+b. Now define b/k as “similar error”. When the similar error is less than a specified value, it is said that L is similar to HL. Consequently, historical price corresponding to HL is selected to compute price forecast.

In alternative method 3 (AM3), “the 1st order curve fitting” means using 1st order curve to fit the mapping between price and load. “2nd order curve fitting” and “3rd order curve fitting” can be similarly defined.

TABLE 5
Comparison of Different Forecasting Methods

| Method | Strategy | MAPE (%) |
|---|---|---|
| Neural network | Non-adaptive | 8.25 |
| | Adaptive | 6.57 |
| AM1 | Using current day data | 7.87 |
| | Using previous day data | 9.89 |
| AM2 | Similar error = 0.05 | 11.35 |
| | Similar error = 0.1 | 11.12 |
| AM3 | 1^{st} order curve fitting | 11.99 |
| | 2^{nd} order curve fitting | 12.12 |
| | 3^{rd} order curve fitting | 12.06 |

Referencing Table 5, it can be seen that the present invention, based on the neural network method with appropriate training strategies of data pre-processing, Type 2 Model (T2M of Table 1) neural network, and four weeks data training, and using appropriate adaptive forecasting strategy, provides better results than alternative methods.

The present invention has thus disclosed systems and techniques for price forecasting for the generating entity in an unregulated electricity market. The present invention recognizes the importance of various factors impacting electricity price forecasting, including: time factors, load factors, historical price factor, line flow limits, line outages, load patterns, bidding patterns and generator outages, etc. A neural network method is used to study the relationship between these factors and the market price and train the neural network accordingly in forecasting the price. The neural network is further adaptively trained with practical data to verify and modify the results from training at both the training and forecasting stages. The present invention further utilizes data pre-processing and trains the network to prevent using too many training vectors or considering too many factors which may degrade price forecasting. A redefined definition of acceptable error is used to avoid the limitation of traditional methods of evaluating the performance of electricity price forecasting. Thus a neural network method, with appropriate training and appropriate adaptive forecasting strategy, provides a good tool for price forecasting when compared to known methods in terms of accuracy as well as convenience. The person having ordinary skill in the art may realize variations of present invention upon gaining an understanding of the present invention. Accordingly, the present invention is to be limited only by the appended claims.

We claim:

1. A method of using an artificial neural network to forecast a market price of electricity comprising:
a) determining relevance of electrical transmission data other than time and load demand to the market price of electricity;
b) verifying the relevance determined in step a) by testing against actual market price data;
c) using the results of step b) to determine an input matrix to a forecasting stage of the artificial neural network by modifying the inputs until an acceptable error rate is achieved;
d) forecasting the market price of electricity over a twenty four hour period by inputting current data into a forecasting stage of the artificial neural network to predict a future market price of electricity;
e) comparing the forecast price to an actual market price of electricity as determined for the same time period and determining an error rate for the forecast price; and
f) adaptively modifying the input matrix until an acceptable error rate is achieved for step e).

2. The method of claim 1 wherein the data include all physical factors affecting the grid for which data are available.

3. The method of claim 1 wherein electrical price data are preprocessed to reduce spikes.

4. The method of claim 1 wherein the error rate is determined by a nontraditional MAPE eliminating problems caused by a very small or zero actual market price of electricity.

5. The method of claim 1 further including using electrical transmission data of electrical transmission congestion and data of electrical supply capacity for transmission lines.

6. The method of claim 1 wherein the market price of electricity is a zonal marginal clearing price (ZMCP).

7. The method of claim 1 wherein the market price of electricity is a locational clearing price (LMP).

8. The method of claim 1 wherein the market price of electricity is a marginal clearing price (MCP).

9. An adaptive forecasting method for forecasting a market price of electricity by an artificial neural network, comprising:
a) developing a training stage of a neural network by utilizing data of at least two factors selected from the group including: transmission line limits, line outages, transmission line maintenance schedule, transmission network congestion statistics, load patterns, types of generators, generator outages, generator capacity, maintenance schedule of generators, bidding patterns, market power of bidders, and line flow;
b) preprocessing at least some of the data to eliminate high degrees of abnormality within the data;
c) determining which factors are relevant to the forecasting method;
d) testing the trained artificial neural network against actual data;
e) developing a forecasting stage for the neural network;
f) matching the training stage to the input matrix of the forecasting stage;
g) forecasting a market price of electricity;
h) checking the forecast prices against actual price data; and
i) adapting the artificial neural network training if the forecast price and the actual price are not matching.

10. The method of claim 9 wherein the step of testing the trained artificial neural network against actual data further includes the use of a nontraditional MAPE thereby eliminating problems caused by a very small or zero actual market price of electricity.

11. The method of claim 10 wherein the step of testing the trained artificial neural network against actual data further includes adapting the weight of relevant factors until a desired accuracy of forecast is obtained.

12. An adaptive forecasting method for determining short-term price of electricity by an artificial neural network comprising:
a) gathering accurate data for physical factors of the grid which may effect bid price of electricity including time, load and congestion data;
b) inputting the factors into the artificial neural network;
c) establish a criterion for analyzing forecasting error for each factor;
d) determining which factors impact price forecasting based on the criterion;
e) using the relevant factors to forecast a bid price of electricity;
f) comparing the forecast bid price of electricity to the actual bid price of electricity; and
g) adjusting the weight or type of factors, or both if the criterion is exceeded.

13. The adaptive forecasting method of claim 12 further comprising: structuring the artificial neural network with 1 input layer, 1 hidden layer and 1 output layer.

14. The adaptive forecasting method of claim 13 further comprising: structuring the artificial neural network with 73 input neurons, 100 hidden neurons and 24 output neurons.

15. The adaptive forecasting method of claim 12 further comprising: structuring the artificial neural network with an adaptive training stage and an adaptive forecasting stage.

16. The adaptive forecasting method of claim 15 further comprising: training the training stage of the artificial neural network with 4 weeks of data.

17. The adaptive forecasting method of claim 15 further comprising: testing the training stage of the artificial neural network with 1 week of data.

18. The adaptive forecasting method of claim 17 further comprising: training the training stage of the artificial neural network with data which has been preprocessed to reduce the affect of price spikes on the forecast.

19. The method of claim 16 wherein the step of testing the trained artificial neural network against actual data further includes the use of a nontraditional MAPE thereby eliminating problems caused by a very small or zero actual market price of electricity.
